(19) United States
(12) Patent Application Publication
(10) Pub. No.: US 2025/0353726 A1
(43) Pub. Date: Nov. 20, 2025

(54) Beverage mixing and dispensing system and tap for use therein

(71) Applicant: Micro Matic A/S, Odense SV (DK)

(72) Inventor: Per-Arne Isaksson, Varberg (SE)

(73) Assignee: Micro Matic A/S, Odense SV (DK)

(21) Appl. No.: 18/962,024

(22) Filed: Nov. 27, 2024

(30) Foreign Application Priority Data
May 14, 2024 (DK) 202470142

(51) Int. Cl. B67D 1/00; B67D 1/14

(52) U.S. Cl. CPC B67D 1/0028; B67D 1/0074; B67D 1/1422

(57) ABSTRACT

A beverage mixing and dispensing system and a dispensing font device and/or dispensing tap configured to dispense a drink (D) from a mixture of at least a first main liquid (F₁) and of a second liquid (F₂) by use of one or more electrical pumps, one or more propellants, one or more regulators, one or more valves, one or more gas or liquid flow regulators and one or more control units operatively connected to enable operation and flow of liquids and propellants from one or more containers containing the liquids when dispensing the drink (D) via one or more beverage dispensing font devices and/or dispensing taps.

This application claims priority under 35 U.S.C. § 119(a) to Danish patent application Ser. No. 20/247,0142, filed on May 14, 2024, the entire disclosure of which is herein incorporated by reference.

### BACKGROUND OF THE INVENTION

### Technical field

The present disclosure relates to dispense of beverages made by mixing drinkable fluids, e.g., mixing still water with carbonated water to produce mildly carbonated water. The present disclosure also relates to a cold beverage dispensing system configured to be operatively coupled to one or more dispensing font devices and/or dispensing taps of beverages. More specifically, the disclosure relates to a beverage dispensing system for dispensing post-mixed drinkable fluids as one common single drink at/from one or more dispensing font devices and/or dispensing taps. Hence, the present disclosure relates to a beverage mixing and dispensing system configured to dispense a drink of a mixture of at least a first main liquid and a second liquid out of one or more dispensing font devices and/or dispensing taps and a beverage dispensing font device or tap for operative and fluid connection to one or more beverage containers of the beverage dispensing system. More specifically, the disclosure relates to a beverage mixing and dispensing system with one or more dispensing font devices and/or dispensing taps configured to dispense a drink from a mixture of at least a first and a second liquid and a beverage dispensing tap configured to be operatively and fluidly coupled to one or more beverage containers of a beverage dispensing system as defined herein.

### Background Art

A problem with solutions of the prior art of beverage dispensing systems for tapping non-carbonated and carbonated liquids mixed into a beverage, i.e. a single drink, before the drink is actually dispensed is that too much foam may be generated when a non-carbonated liquid, such as a concentrate or an essence or a syrup, is mixed with a carbonized liquid, such as water, during the mixing and/or dispensing into a receptacle.

Exemplary beverage dispensing systems are disclosed, e.g., in U.S. Pat. No. 3,347,421 (T.O. Yingst et al) and U.S. Pat. No. 5,601,210 (D. Kelly et al), the entire contents of which are incorporated herein by reference.

There is, thus, a need for an improved beverage dispensing system and beverage dispensing font device with tapping handle used for dispensing beverages being a mixture of at least two liquids via taps.

### SUMMARY

It is an object of the present disclosure to mitigate, alleviate or eliminate one or more of the above-identified deficiencies and disadvantages in the prior art and solve at least the above-mentioned problem. According to a first aspect there is provided a beverage mixing and dispensing system configured to dispense a drink of a mixture of at least a first main liquid, e.g. water or beer, and of a second liquid, e.g. a concentrate such as syrup, by use of one or more electrical pumps, one or more propellants, one or more regulators, one or more valves, one or more gas and liquid flow regulators, one or more sensors, and one or more control units operatively connected to enable operation and flow of liquids and propellants from one or more containers containing the liquids when dispensing the drink via one or more beverage dispensing font devices and/or dispense/dispensing members/taps, wherein a beverage dispensing font device includes one or more of the dispense/dispensing members or taps protruding from the beverage dispensing font device into a free dispense end including a tapping handle to manually control dispensing of the drink from an outlet at the free dispense end, the beverage dispensing font device includes a inner guide channel to guide and accommodate a cooling circuit to provide or keep the liquids and the drink at a predetermined temperature until being dispensed out of the outlet at the free dispense end and a first separate supply line for the first liquid and a second separate supply line for the second liquid, which supply lines are arranged to be in fluid communication with the outlet at the free dispense end, whereby the flows of the liquids are controlled by the tapping handle being operatively connected to the control unit/-s configured to operate the valve/-s, the flow regulator/-s, the electrical pump/-s and the propellant/-s in response to activation or de-activation of the dispensing of the drink by means of tilting the tapping handle, preferably by help of feedback from the one or more sensors arranged in the dispense member(s)/tap(s) and operatively connected to the control unit/-s, wherein the first separate supply line for the first liquid and the second separate supply line for the second liquid are arranged to enable the separate flows of each liquid to join and mix at the outlet of the free dispense end of the dispense member(s)/tap(s) when activating the dispensing by means of operating, preferably via manual tilting of the tapping handle that triggers the control unit/-s to operate the valve/-s, the flow regulator/-s, the electrical pump/-s and the propellant/-s to enable flow of each liquid through the supply lines and to the outlet at the free dispense end of the dispense member(s)/tap(s) in a synchronized manner by initiating, e.g., starting, the separate flow of the first liquid before initiating, e.g., starting, the separate flow of the second liquid.

This delays the mixing of the second liquid into the first liquid, whereby development of foam is controlled precisely and even eliminated or at least controlled or reduced into a desired amount of foam in the drink then being dispensed-after the mixing of the at least one first main liquid and the at least one second or secondary liquid into the single drink-out of the outlet of the dispense member/tap.

According to some embodiments, the separate flow of the first liquid is initiated or started shortly before the separate flow of the second liquid is initiated/started.

This delays the mixing of the second liquid into the first liquid more precisely, whereby development of foam is controlled more exactly and elimination of foam is more precisely done or at least controlled more accurately or foam is more carefully reduced into a desired amount of foam in the mixed single drink being dispensed-after the mixing of the at least one first main liquid and the at least one second or secondary liquid into a mixture of the single drink-out of the outlet of the dispense member/tap.

According to some embodiments, the separate flow of the first liquid is initiated or started about between 0.1 second to 3 seconds before the separate flow of the second liquid is initiated/started or the separate flow of the first liquid is preferably initiated about between 0.1 second to 2 seconds before the separate flow of the second liquid is initiated/started or the separate flow of the first liquid is more preferred initiated/started about between 0.1 second to 1 second before the separate flow of the second liquid is initiated/started.

This delays the mixing of the second liquid into the first liquid even more precisely, whereby development of foam is controlled even more exactly and elimination of foam is even more precisely done or at least controlled even more accurately or foam is even more carefully reduced into a desired amount of foam in the mixed single drink being dispensed—after the mixing of the at least one first main liquid and the at least one second or secondary liquid into a mixture of the single drink-out of the outlet of the dispense member/tap.

According to some embodiments, the separate flow and carbonization of the first liquid is initiated or started before the separate flow of the second and non-carbonated liquid is initiated or started.

This delays the mixing of the second non-carbonated liquid into the first carbonized liquid with a preferred precision, whereby development of foam is controlled even better and elimination of foam is further enhanced or at least controlled in a more effective way or foam is more surely and robustly reduced into a desired amount of foam in the mixed single drink being dispensed-after the mixing of the at least one first main liquid and the at least one second or secondary liquid into a mixture of the single drink-out of the outlet of the dispense member/tap.

According to some embodiments, the first separate supply line for the first liquid is configured to open into the second end of the dispense/dispensing tap/member upstream an inner opening configured to discharge the secondary fluid coming from the second separate supply line inside the outlet of the dispense/dispensing tap/member.

According to some embodiments, the inner opening of the second separate supply line for discharge of the second liquid is configured to open into and inside the outlet of the dispense/dispensing member/tap closer to the outlet than the first separate supply line.

According to some embodiments, the first separate supply line for the first liquid is configured to extend inside the beverage dispensing font device and to end and open into a second end of the dispense member/tap opposite the free end and the second separate supply line for the second liquid is configured to extend inside the beverage dispensing font device to the second end of the dispense member/tap and to extend from the second end of the dispense member/tap out of and outside of the dispense member/tap and to join and end and open into the outlet at the free end of the dispense member/tap.

According to some embodiments, the first separate supply line for the first liquid is configured to extend inside the beverage dispensing font device and to end and open into a second end of the dispense member/tap opposite the free end and the second separate supply line for the second liquid is configured to extend inside the beverage dispensing font device to the second end of the dispense member/tap and to extend from the second end of the dispense member/tap inside the dispense member and end and open into the outlet at the free end of the dispense member/tap downstream of the opening of the first separate supply line.

According to a second aspect there is provided a beverage dispensing tap system configured to be operatively and fluidly coupled to one or more beverage containers, e.g., as part of a beverage dispensing system according to the first aspect and/or any of the former/above embodiments, wherein the one or more beverage containers are part of two separate and operatively interconnected beverage dispensing units fluidly coupled to the beverage dispensing tap, a first beverage dispensing unit including one or more first containers that in turn includes at least a second liquid, e.g., a non-carbonated concentrate such as syrup, configured to be dispensed through the beverage dispensing tap by means of one or more electrical pumps and a second beverage dispensing unit including one or more second containers that in turn includes at least a first liquid, e.g. water or beer, configured to be propelled out of the respective container by use of pressurized gas, e.g., carbon dioxide and/or nitrogen, to be dispensed through the beverage dispensing tap and out of the outlet of the beverage dispensing tap together with the second liquid as a mixture and single drink by means of operating, preferably by manually handling or maneuvering or tilting or toggling or rocking or moving or pivoting a tap handle of the beverage dispensing tap configured to thereby control the dispensing of the at least two liquids as the mixed drink such that the propelling and dispensing of the at least first liquid is initiated and/or started before the dispensing of the at least second liquid is initiated and/or started.

According to some embodiments, the separate flow of the first liquid is initiated shortly before the separate flow of the second liquid is initiated.

According to some embodiments, the separate flow of the first liquid is initiated about between 0.1 second to 3 seconds before the separate flow of the second liquid is initiated or the separate flow of the first liquid is preferably initiated about between 0.1 second to 2 seconds before the separate flow of the second liquid is initiated or the separate flow of the first liquid is more preferred initiated about between 0.1 second to 1 second before the separate flow of the second liquid is initiated.

According to some embodiments, the separate flow and carbonization of the first liquid is initiated before the separate flow of the second and non-carbonated liquid is initiated.

According to some embodiments, the first separate supply line for the first liquid is configured to open into the second end of the dispense/dispensing tap/member upstream an inner opening configured to discharge the secondary fluid coming from the second separate supply line inside the outlet of the dispense/dispensing tap/member.

According to some embodiments, the inner discharge opening of the second separate supply line is configured to open into the dispensing tap at/in the free dispense end closer to the outlet than the opening of the first separate supply line.

According to some embodiments, the first separate supply line for the first liquid is configured to extend into the beverage dispensing tap and to end and open into a second end of the dispensing tap opposite the free discharge end and the second separate supply line for the second liquid is configured to extend from the second end of the dispensing tap out of and outside of the dispensing tap and to join and end and open into the outlet at the free end of the dispensing tap and the inner discharge opening inside the outlet.

According to some embodiments, the first separate supply line for the first liquid is configured to extend into the beverage dispensing tap and to end and open into a second end of the dispensing tap opposite the free dispensing end and the second separate supply line for the second liquid is configured to extend from the second end of the dispensing tap inside the dispensing tap and end and open into the outlet and the inner discharge opening inside and at the free end of the dispensing tap downstream of the opening of the first separate supply line.

According to some embodiments, the beverage dispensing tap includes an adjustable compensator configured to control the flow of the at least first liquid.

Effects and features of the second aspect, i.e. the one or more beverage dispensing font devices and/or taps are to large extent analogous to those described above in connection with the first aspect of the beverage dispensing system as one or more beverage dispensing font devices and/or taps is/are applicable in the beverage dispensing system. Embodiments mentioned in relation to the first aspect are also largely compatible with the second aspect and any of its associated embodiments. This lets the beverage dispensing system inherit the same advantages as those of the dispensing font device and/or the tap and vice versa as these entities cooperate and operate together to provide proper dispensing of beverage as a whole.

Hence, it is to be understood that the herein disclosed disclosure is not limited to the particular component parts of the beverage dispensing system and beverage dispensing font device/-s/tap/-s described or steps of any methods described since such a system, device and method may vary. It is also to be understood that the terminology used herein is for purpose of describing particular embodiments only, and is not intended to be limiting. It should be noted that, as used in the specification and the appended claim, the articles “a”, “an”, “the”, “said”, the ending “/-s” and similar or the same numerals are intended to mean that there are one or more of the same or similar elements unless the context explicitly dictates otherwise. Thus, for example, reference to “a system or device or unit” or “the system/device/unit” may include several entities and/or members and/or parts and/or devices, and the like. Furthermore, the words “including”, “including”, “containing” and similar wordings does not exclude other elements or steps. Furthermore, a “fluid” or “liquid” does not exclude that a gas may be included in the “fluid” or “liquid”, i.e. the “fluid” or “liquid” may be a mixture of one or more fluids/liquids and one or more gases depending on where in the flow of liquids/fluids and beverages during dispensing the disclosure relates. The definitions of “upstream” and “downstream” are related to the flow directions of the liquids and/or gases.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1A shows in perspective a dispensing tap of a beverage dispensing system according to an embodiment of the present disclosure.

FIG. 1B shows in perspective a dispensing tap of a beverage dispensing system according to an embodiment of the present disclosure.

FIG. 2A shows a partly perspective and cross-sectional view of a dispensing tap of a beverage dispensing system according to an embodiment of the present disclosure.

FIG. 2B shows a partly perspective and cross-sectional view of a dispensing tap of a beverage dispensing system according to an embodiment of the present disclosure.

FIG. 3 show in perspective a beverage dispensing system according to an embodiment of the present disclosure.

FIG. 4 shows a perspective view of a beverage dispensing system according to an embodiment of the present disclosure.

FIG. 5A shows a plan side cross-sectional view of a beverage dispensing system according to an embodiment of the present disclosure.

FIG. 5B shows a plan side cross-sectional view of a beverage dispensing system according to an embodiment of the present disclosure.

FIG. 6 shows a plan view from one end of the dispensing tap of the beverage dispensing system according to FIGS. 2A and 2B viewed along arrows A-A in a plane visualized by the dot and dashed line, i.e., from the inlet end, after disassembly or before assembly of the dispensing tap from or to the beverage dispensing system.

FIG. 7 shows a cross-sectional view of the dispensing tap along line B-B in FIG. 6 with the inlet end to the right.

FIG. 8 shows a cross-sectional view similar to the view of FIG. 7 but of a dispensing tap according to another embodiment of the present disclosure with the inlet end to the right.

FIG. 9 shows a cross-sectional view similar to the views of FIGS. 7 and 8 but of a dispensing tap according to yet another embodiment of the present disclosure with the inlet end to the right.

### DETAILED DESCRIPTION OF THE PREFERRED EMBODIMENT

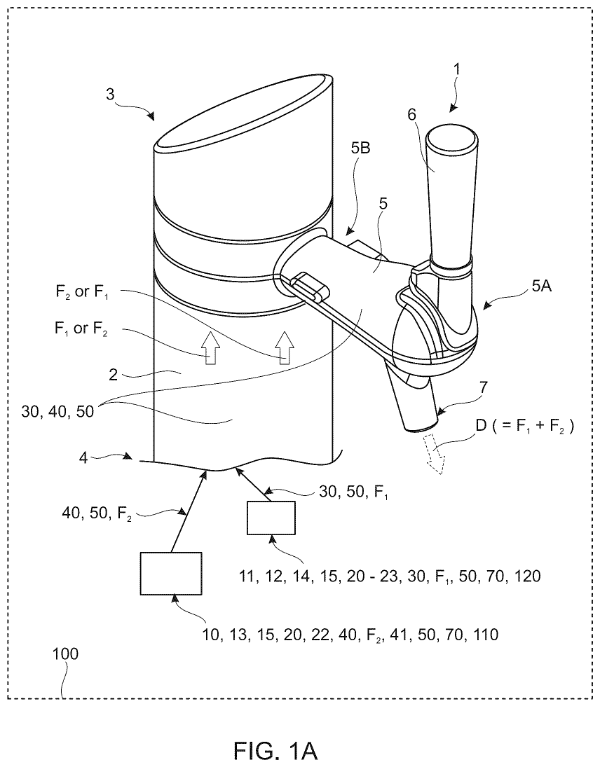

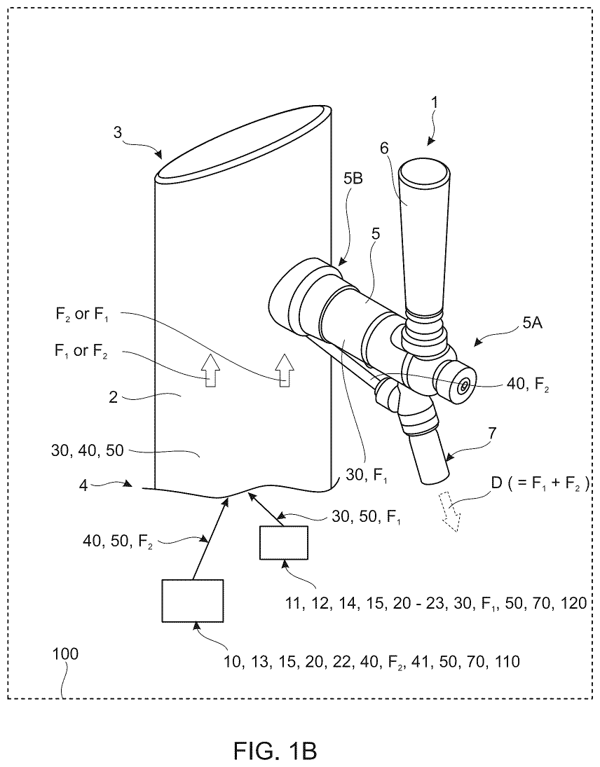

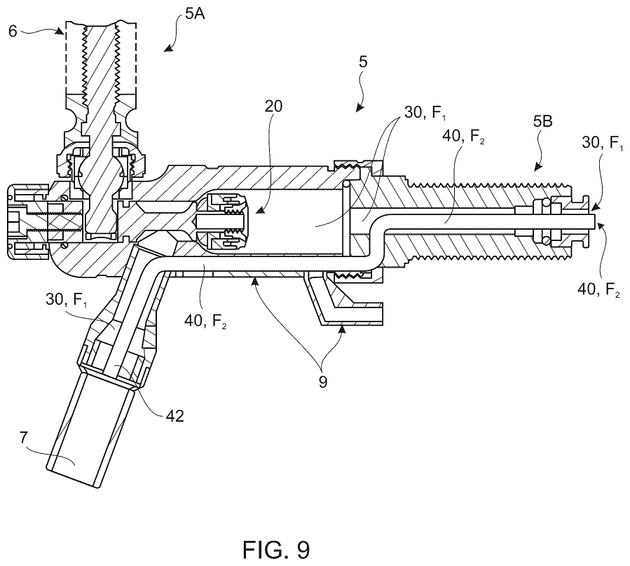

The present disclosure will now be described with reference to the accompanying drawings FIGS. 1A to 9, in which at least one preferred example embodiment of the disclosure is shown. The disclosure may, however, be embodied in other forms and should not be construed as limited to the herein disclosed embodiments. The disclosed embodiments are provided to fully convey the scope of the disclosure to the skilled person. All the figures are highly schematic and not necessarily to scale, and they show only those parts which are necessary in order to elucidate the invention, other parts being omitted or merely suggested.

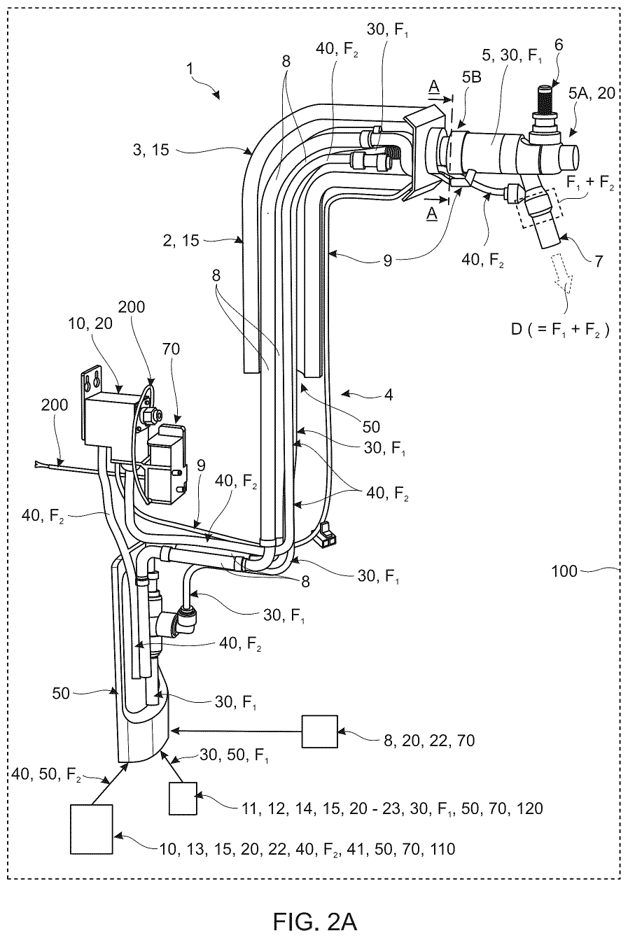

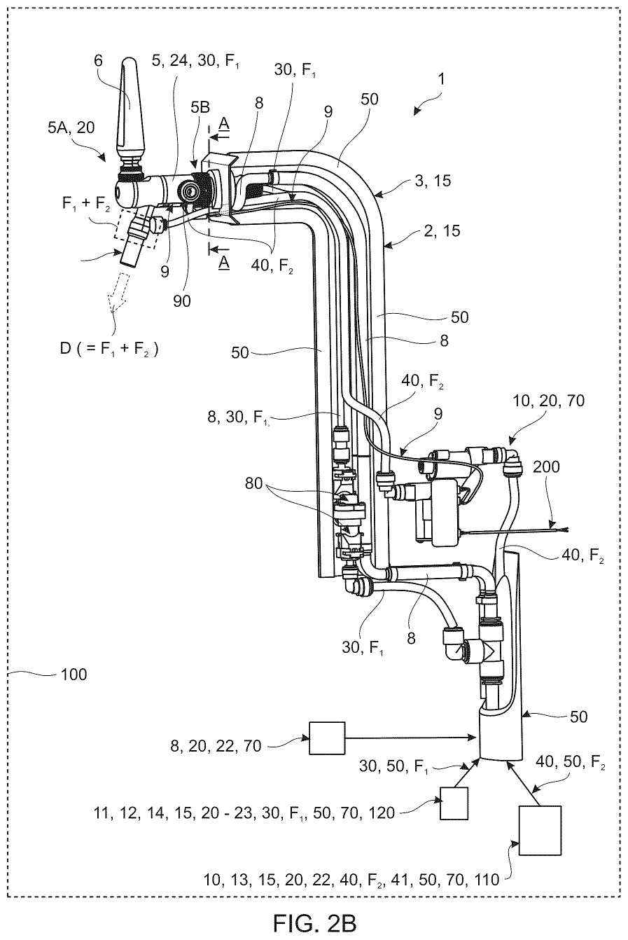

In FIGS. 1A to 5B, at least one dispensing font device 1/dispensing tap 5 for a beverage dispensing system 100 for dispensing beverage made by mixing at least two fluids F₁ and F₂ according to the disclosure is shown. FIGS. 1A, 1B, 2A and 2B show a dispensing font device 1 as part of a beverage dispensing system 100 according to the disclosure with the beverage dispensing system 100 only shown schematically by means of a dashed box. The beverage dispensing font device 1 includes a first font part 2 forming a tower having a first upper end or neck 3 and a second lower end 4, and a substantially horizontal second font part or tap 5 connected with the first font part 2 at the first upper end 3. The lower end 4 of the tower 2 is configured to be detachably attached to a bench or desk or table or bar or counter and configured with an opening facing downwards to enable at least two liquid and beverage supply lines 30, 40 to be lead through the bench or desk or table or bar or counter into the lower end 4 and through the beverage dispensing font device 1 via a guide channel 50 to be in fluid communication with one or more outlets 7 of the substantially horizontal second font part or dispensing tap 5 of the beverage dispensing font device 1.

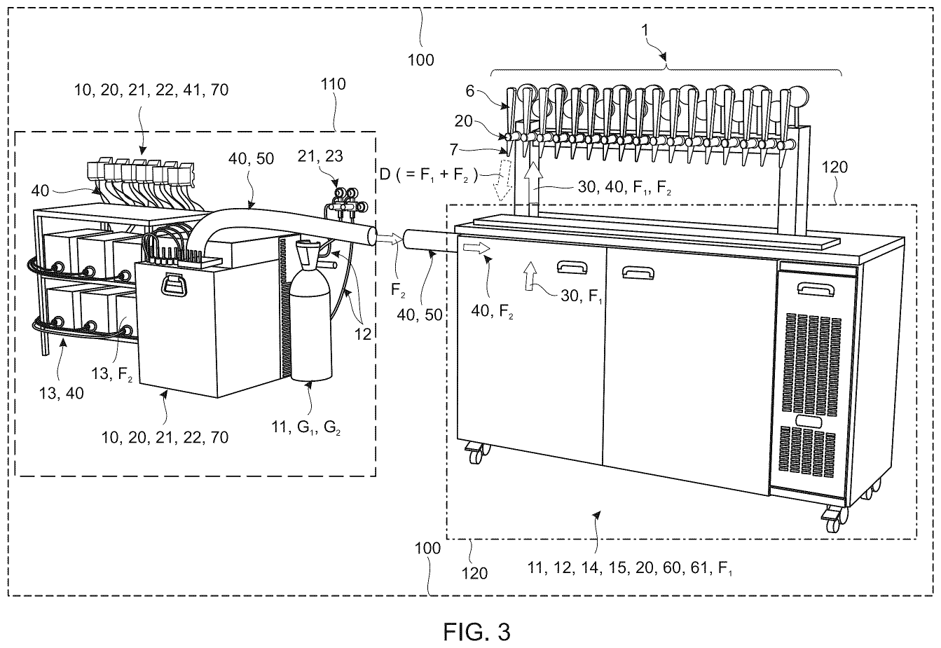

In FIGS. 1A, 1B, 2A and 2B, the second font part or tap 5 is shown including a tapping handle 6 being configured to open and close-during use-an outlet of one or more dispensing lines 30, 40 extending through the dispensing font device 1 and/or at least partly through the tap 5. Each first font part 2 includes one or more outlets or nozzles 7 out of which the mixed single beverage or drink D is dispensed into a glass or cup or bottle or the like. The dispensing font device 1 includes an inner cooling circuit 8 extending through the inside of the tower 4 and the neck 3 to cool and/or keep any beverage flowing through the dispensing line(s) 30, 40 cold. The cooling circuit 8 extends also through the second font part/tap 5. The first upper end or neck 3 is extending vertically as shown in FIGS. 1A, 1B, 3, 5A and 5B. The first upper end or neck 3 has a curved or bent shape as shown in FIGS. 2A and 2B. In FIGS. 2A and 2B, a sensor cable or line 9 is operatively connected with one upper end to a sensor at/on/in the horizontal second font part/tap 5 and with the other end to a regulator 10 to provide a feedback loop of signals from the sensor determining the status and correct composition of the single common beverage D during use/operation when being dispensed after mixing at least two or more liquids F₁, F₂ and/or gases G₁, G₂. The sensor 9 and its associated and connected cable is denoted with numeral 9 throughout the specification for simplicity. The regulator 10 also includes at least one control unit 70 for its operation and the operation of the beverage dispensing system 100 and/or the dispensing font device 1 and/or the tap 5. The system 100 includes at least one control unit 70 operatively connected to associated components, such as one or more valves 20, 21; one or more regulators 22, 23, 80; one or more sensors 9; and one or more tap handles 6 etc. (see FIGS. 3, 4, 5A and 5B, e.g., system 120 in FIG. 3 shows no control unit 70 but could of course comprise one or more such control units or be operatively connected to the control unit 70 in the system 100 or 110 of FIG. 3 working as a master control unit) to control the flow of each fluid F₁ and/or F₂ including the cooling liquid of one or more cooling circuits 8. Supply and/or bleeding off or bypassing of cooling liquid of the cooling circuit 8 is controlled by means of one or more control units, e.g., corresponding to the control unit/-s 70, and one or more sensors, such as one or more sensors 9, and one or more valves 20 and one or more regulators 22, 80.

The control unit 70 and/or one or more other control units is/are in electrical communication by wiring 200 with each other and/or the valve 20 and/or one or more other valves 21 and/or one or more electrical pumps 41 and/or one or more sensors 9 to enable the liquids F₁, F₂ and/or gases G₁, G₂ to be mixed when dispensing by manually operating/moving the tapping handle/-s 6 in different directions, whereby the control unit(s) 70 and associated equipment automatically operate in response thereto to start or stop dispensing. One or more of the liquids F₁, F₂ could be still water, carbonated water, syrup, coffee, tea or the like. One or more of the gases G₁, G₂ could be carbon dioxide CO₂ and/or nitrogen N₂. These gases are pressurized and stored in one or more containers 11.

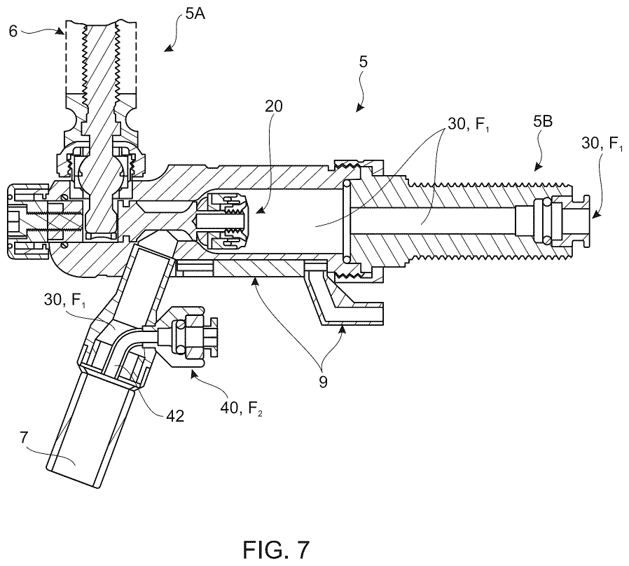

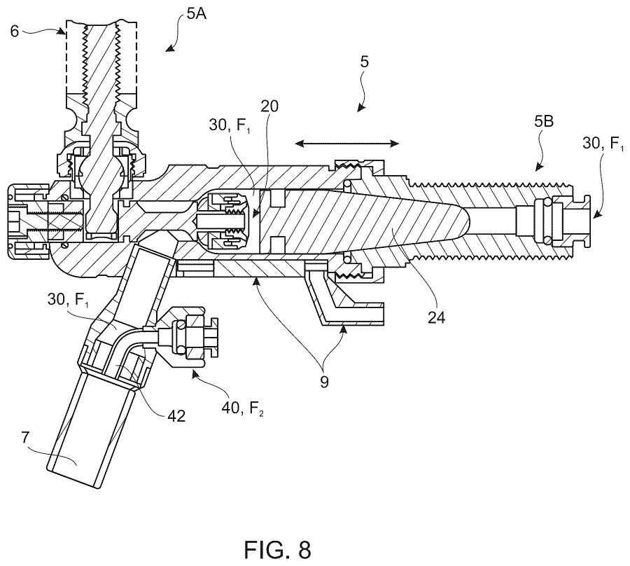

One or more first or main or primary liquids or fluids F₁ are supplied in one or more primary lines 30 into the dispensing font device 1 and/or the tap 5 during use. One or more second or secondary liquids or fluids F₂ are supplied in one or more secondary lines 40 into the dispensing font device 1 and/or the tap 5 during use. The regulator 10 is configured to dose the correct amount of one or more secondary liquids/fluids F₂ flowing through the regulator by means of one or more controllable valves 20 as shown in FIG. 7 and/or by means of one or more compensators 24 as shown in FIG. 8 and/or one or more break lines in the form of a conduit or tube 40 with an adapted length as shown in FIG. 2A to be mixed with one or more of the primary liquids/fluids F₁ at/in the second font part or the tap 5 before being dispensed out of the outlet/-s or nozzle/-s 7 as a common single mixed drink D.

In beverage dispensing systems, a “break line” typically refers to a point in the fluid line where the flow can be interrupted or adjusted. This is often achieved using a valve or a flow regulator. The flow regulators are used to maintain a consistent flow rate despite variations in pressure. The flow regulators can be adjusted to set the desired flow rate for the beverage being dispensed. The valves can be manually or automatically operated to start, stop, or adjust the flow of the beverage by means of control units controlling pumps etc. with help of feedback from sensors. By adjusting the valve(s), the amount of liquid that passes through is controlled, effectively setting the flow rate. There is also common to use Brix adjustment in post-mix systems, the Brix ratio (e.g., the ratio of syrup to water) is adjusted using specific screws or valves ensuring the correct mixture and flow rate of the beverage. The conduit or tubes leading the fluid can also be adapted in length, e.g., is plastic tubing is used, the tube can be cut to certain length to adjust the flow and/or pressure to provide a proper dispensing without too much foaming etc. These components are crucial for ensuring that beverages are dispensed at the correct rate and consistency, maintaining quality and customer satisfaction.

According to the disclosure, as shown in FIG. 2B, a pressure regulating device or pressure regulator 80 is arranged between the lowermost T-piece of FIG. 2B and fluidly connected to both the first or main or primary line 30 for the main or primary liquid or fluid F₁and the cooling circuit 8 to be able—on demand—to bleed off or provide a small bypass or takeout of some cold carbonized water from the cooling circuit 8 to mix with the first or main fluid F₁ in the main line 30 as a smaller stream of cooling water from the cooling circuit 8 and lead a mix of the first fluid F₁ with more or less or some bled off cooling water 8 to the tap 5 and then out of the outlet 7 as a soda or soft drink directly or lead the first fluid F₁ mixed first with some of the cooling water 8 by means of the pressure regulator 80 into the spout 7 to mix further together with the second fluid F₂ as the drink D before being tapped or dispensed. However, this pressure regulator 80 is mainly or usually or only used for soda or soft drinks as otherwise the pressure at the tap 5 would be too high if used for beer creating too much foam when dispensing, i.e., tapping.

In FIGS. 1A to 5B, a beverage dispensing system 100 and a first beverage dispensing unit 110 and a second beverage dispensing unit 120 are shown. The beverage dispensing system 100 includes one or more first beverage dispensing units 110 and one or more second beverage dispensing units 120. The first and second beverage dispensing units 110 and 120 are configured to operatively interact enabling mixing one or more of the first liquid/-s F₁ with one or more of the second liquid/-s F₂ into a single common beverage or drink D to be tapped out of the outlet 7 by means of operating the tap handle 6 that in turn powers the associated equipment, such as the control unit/-s 70, one or more electrical pumps 41, and propellant means, such as one or more pressurized containers 11. The containers 13 and 14 are a single one in each beverage dispensing unit 110 or 120 or a plurality, e.g., more than two containers 13, 14 arranged in a rack, in each beverage dispensing unit 110 or 120.

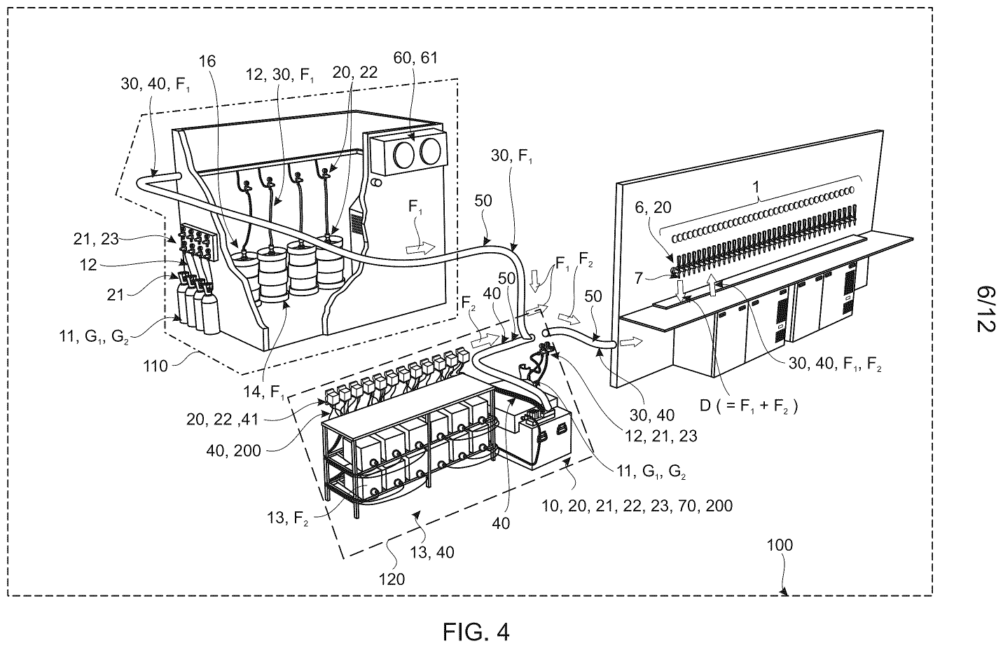

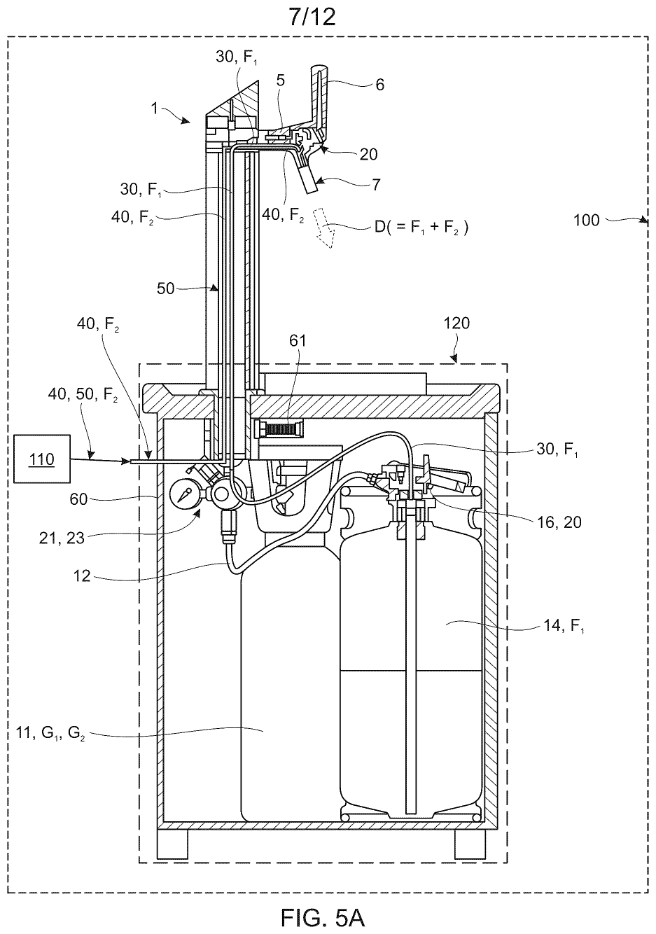

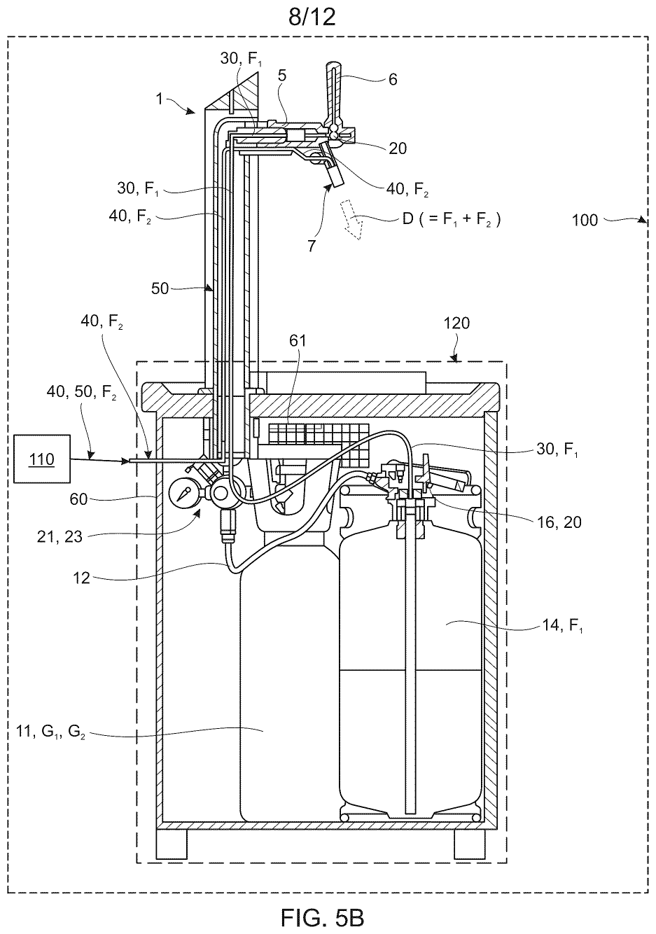

The beverage dispensing system 100 includes in some embodiments one or more housings or rooms 60 enclosing one or more first and/or second beverage dispensing units 110, 120. The beverage dispensing system 100 includes at least one housing or room 60 configured to house one or more first and second beverage containers 13, 14. The housing(s) 60 is in some embodiments provided with one or more cooling units 61 to provide and/or keep beverage in the second container/-s 14 of the second beverage dispensing unit/-s 120 with/at a predetermined temperature and is further provided with circulating means for circulating cooled air in the housing 60. The housing(s) 60 is provided with one or more cooling units 61 to keep the beverage in the first container/-s 13 of the first beverage dispensing unit/-s 110 at a pre-determined temperature and is provided with circulating means for circulating cooled air in the housing(s) 60. The housing(s) 60 (see FIGS. 5A and 5B) includes propelling means, or propelling means may be connected to the second beverage container 14 in the housing(s) 60 of the second beverage dispensing unit/-s 120 as shown in FIG. 4. The propelling means may be a gas G₁, such as CO₂ or N₂, or may be a pressure chamber utilizing pneumatic or mechanical pressure means to force beverage out of the second container/-s 14. The propelling means is gas contained in one or more gas cylinders 11 being connected via one or more gas lines 12 to one or more dispense heads 16 to be connected with the second container/-s 14. The dispensing line 30 extends from the second container/-s 14 up through a guide channel 50 of the dispensing font device 1 to the second font part or tap 5 of the dispensing font device 1 including the tapping handle 6 configured to open one or more valves 20 for dispensing and close one or more valves 20 to stop dispensing when correctly positioned in the second font part/tap 5. The dispensing line 40 extends from the first container/-s 13 up through the guide channel 50 of the dispensing font device 1 to the second font part or tap 5 of the dispensing font device 1 including the tapping handle 6 configured to open one or more valves 20 for dispensing and close one or more valves 20 to stop dispensing when correctly positioned in the second font part or tap 5.

Preferably, the beverage dispensing system 100 includes one or more first beverage dispensing units 110 including one or more first containers 13 containing syrup and/or concentrate F₂ or the like. Preferably, the beverage dispensing system 100 includes one or more second beverage dispensing units 120 including one or more second containers 14 containing beer and/or water F₁ or the like. Each second container 14 of the second beverage dispensing unit/-s 120 includes a dispense head 16 and a container valve 21 arranged in an opening or outlet of the second beverage container 14, see FIGS. 4, 5A and 5B. The container valve has in some embodiments an internal spring with a spring force enabling the opening or outlet of the second container 14 to be kept closed. The beverage dispensing system 100 includes one or more gas supplies or gas lines 12, e.g. in the form of one or more gas containers 11 (FIG. 3 shows one first gas container 11, FIG. 4 shows five gas containers 11, one used in the first beverage dispensing unit/-s 110 (see the top of the gas container 11 to the right of the first beverage dispensing unit/-s 110 and four gas containers 11 outside the housing 60 of the second beverage dispensing unit/-s 120 to the left, one dispensing handle or tap 6 in FIGS. 1A, 1B, 2A, 2B, 5A and 5B or more dispensing handles or taps 6 to the right in FIGS. 3 and 4 (seventeen (17) taps 6 in FIG. 3 and thirty-six (36) taps 6 in FIG. 4), and one or more dispense nozzles or outlets 7 (corresponding to the number of taps 5) according to the disclosure. One or more of the tapping handles 6 control more than one outlet 7 if one or more of the beverage dispensing font devices 1 and/or taps 5 includes more than one outlet 7 each, this may be the case in some embodiments not shown. One or more gas supplying containers 11 is/are connected with one or more gas inlets of one or more dispense heads 16 via one or more gas and/or liquid regulators 23 and one or more gas supply lines 12. From the dispense head 16 to the beverage container/-s 14 and/or the dispensing system 100, one or more gas supply lines 12 extend. Preferably, a dispensing line 30 may be configured to be guided from a dispense head 16 to the dispensing tap 5 via the tower 4 of the font 1 or from the dispensing tap 5 via the tower 4 to the dispense head 16.

The gas supplying container/-s 11 contains a pressurized gas G₁, G₂, e.g. CO₂ and/or nitrogen N₂ as propellant to force beverage out of the container/-s 14.

The regulator 23 for the gas G₁, G₂ could be a gas pressure regulation device, e.g. as disclosed in WO 2019/110714 A1. The beverage dispensing system 100 includes a gas delivering system that in turn includes one or more CO₂ or N₂ cylinders 11 having a valve assembly and a gas pressure regulation device as in the second beverage dispensing unit/-s 120. Such a gas delivery system is configured to deliver a predetermined gas pressure to one or more of the second beverage container/-s 14 having an extractor tube or line as the dispensing line/-s 12. A dispense head 16 is coupled to the extractor tube or dispensing line 12 and is configured to lead CO₂ (G₁) and/or N₂ (G₂), from the gas container or cylinder 11 through the valve assembly in the gas container 11 and the gas pressure regulation device 23 to and through the gas supply line 12 into the second beverage container 14 wherein the CO₂/N₂ is used to expel the beverage F₁ from the beverage container 14 into the extractor tube and dispensing line 30 and through the tower 4 and the guide channel 62 and out of the nozzle 7 when the tapping handle 6 is opened to enable dispensing of the drink D.

The dispensing font device 1 and/or tap 5 of the disclosure is fluidly coupled to one or more liquid/fluid/beverage containers 13, 14 via one or more valves 20, 21 and/or regulator/-s 22, 23 and/or electrical pumps 41 and/or propelling means 11, 12 and/or compensators 24 and/or pressure regulators 80. The liquid/fluid in one or more or a first container 13 is water, concentrate and/or syrup, coffee, tea or another non-alcoholic or alcoholic beverage, such as soda and/or soft drink, such as wine or vodka. The liquid/fluid in one or more or a second container 14 is water or beer or another non-alcoholic or alcoholic beverage such as soda and/or soft drink. A container valve is configured to be opened by pressing it downwards into the second beverage container 14 by means of a lower end of a piston of a dispense head 16. Hereby, the container valve opens up for beverage to flow out of the beverage container 14 by pressurising the inside of the beverage container with a pressurized gas G₁, G₂, such as CO₂ and/or N₂, coming from a gas container 11 via line/-s 12 and/or valve/-s, as is well known in the art and not explained further herein.

The tap handle 6 of the dispensing font device 1 and/or the dispensing tap 5 is removably and tiltable attached to the horizontal second font part or member or tap 5. The tiltable/pivotable tap handle 6 has a free end forming a grip to move the handle with when used and when detached from and attached to the dispensing tap 5.

In a preferred aspect, one or more beverage dispensing font devices 1 and/or taps 5 are configured to be operatively coupled to one or more beverage containers 13, 14 in a beverage dispensing system 100 including one or more beverage dispensing units 110, 120, which beverage dispensing font device/-s 1 and/or taps 5 each include/-s a dispense handle 6 configured to operate/control dispensing of the drink D according to the disclosure.

In a preferred aspect, a beverage dispensing system 100 and/or a beverage dispensing font device 1 and/or a beverage dispensing tap 5 is operated by means of a method of dispensing a drink D from a mixture of a first liquid F₁, e.g. water or beer, and of a second liquid F₂, e.g. a concentrate such as syrup, wherein the first liquid F₁ is carbonated and the dispensing of the first liquid F₁ is initiated, i.e. started, before the dispensing of the second liquid F₂ is initiated, i.e., started.

The first aspect of this disclosure shows a beverage mixing and dispensing system 100 configured to dispense a drink D from a mixture of at least a first main liquid F₁, e.g. water, soda, soft drink or beer, and of a second liquid F₂, e.g., a concentrate such as syrup. This is done by use of one or more electrical pumps 41, one or more of the propellants G₁,G₂, one or more of the regulators 10, one or more of the valves 20, 21 and/or one or more of the compensators 24 and/or one or more of the break lines 40 with an adapted length, one or more of the gas or liquid flow regulators 22, 23 and one or more of the control units 70 and/or one or more of the pressure regulators 80, which are operatively connected to enable operation and flow of liquids F₁, F₂ and propellants G₁, G₂ from one or more containers 13, 14 containing the liquid/-s F₁, F₂ and/or the propellant/-s G₁, G₂ when dispensing the drink/-s D via one or more of the beverage dispensing font devices 1. Each pump 41, each valve 20, 21, each gas or liquid flow regulator 22, 23, each compensator 24, each control unit 70, each pressure regulator 80, and any other regulating device and/or means is of course usually driven by electricity and operatively cooperating with associated sensors, such as sensors similar to sensor 9, to enable desired control of the beverage mixing and dispensing system 100, in particular for the timing of starting and stopping the flow of each fluid F₁ and/or F₂ and to control flow of the cooling liquid in the cooling circuit 8. Each beverage dispensing font device 1 includes a vertical first font section 2 configured as a tower. The tower 2 has an upper end 3 and a lower end 4 and a dispense member or tap 5 protruding from the upper end 3 into a free discharge or dispensing end 5A. The free dispensing end 5A includes one or more tapping handles 6 to manually control dispensing of the drink D from one or more outlets 7 at one or more free dispensing ends 5A. The beverage dispensing font device 1 also includes an inner guide channel 50 to guide and accommodate a cooling circuit 8 to keep the liquids F₁, F₂ and the drink D at a predetermined temperature (usually lower than the surrounding) until the drink D is dispensed out of the outlet 7. The inner guide channel 50 is also configured to guide and accommodate one or more first separate supply lines 30 for the first liquid F₁ and one or more second separate supply lines 40 for the second liquid F₂. The supply lines 30, 40 are arranged to be in fluid communication with more outlets 7 if the beverage dispensing font devices 1 and/or taps 5 includes more than one outlet 7. The flows of the liquids F₁, F₂ are controlled by the tapping handle 6. The tapping handle 6 is operatively connected to the control unit/-s 70 configured to operate the valve/-s 20, 21 and the flow regulator/-s 22, 23 and/or the pressure regulator/-s 80 in response to activation or de-activation of the dispensing of the drink D by means of tilting the tapping handle 6 and feedback from one or more sensors 9 arranged in the dispense member or tap 5 and/or at other suitable locations and operatively connected to the control unit/-s 70 and/or the pressure regulator/-s 80 by sensor cables and wiring 200. Preferably, the first separate supply line 30 for the first liquid F₁ and the second separate supply line 40 for the second liquid F₂ are arranged to enable the separate flows of each liquid to join and mix at the outlet 7 when activating the dispensing by means of manual tilting of the tapping handle 6. When operated, the tapping handle triggers the control unit/-s 70 to operate the valve/-s 20, 21 and/or the flow regulator/-s 22, 23 to enable flow of each liquid F₁, F₂ from the respective containers 13, 14 and through the associated supply lines 30, 40 and to the outlet/-s 7 in a synchronized manner by initiating/starting the separate flow of the first liquid F₁ before initiating/starting the separate flow of the second liquid F₂. Preferably, the separate flow of the first liquid F₁ is initiated, i.e., started shortly before the separate flow of the second liquid F₂ is initiated, i.e., started. Preferably, the separate flow of the first liquid F₁ is initiated, i.e., started, about between 0.1 second to 3 seconds before or more preferred started about between 0.1 second to 2 seconds before or most preferred started about between 0.1 second to 1 second before the separate flow of the second liquid F₂ is initiated, i.e., started. Preferably, the separate flow and carbonization of the first liquid F₁ is initiated, i.e. started and done before the separate flow of the second and non-carbonated liquid F₂ is initiated, i.e., started. Preferably, the separate flow of the first liquid F₁ is initiated, i.e., started, and mixed with a bled off or bypassed small stream of cooling water from the cooling circuit 8 by means of the pressure regulator 80 shortly before the separate flow of the second liquid F₂ is initiated, i.e., started. Preferably, the separate flow and carbonization of the first liquid F₁ is initiated, i.e. started, and mixed with a bled off or bypassed small stream of cooling water from the cooling circuit 8 by means of the pressure regulator 80 and done before the separate flow of the second and non-carbonated liquid F₂ is initiated, i.e., started. Preferably, the flow of the first fluid F₁ starts or is initiated, i.e., started immediately upon activating the tap 5, e.g., when tilting the handle 6, whereafter or subsequently the flow of the second fluid F₂ is initiated, i.e., started, about between 0.1 second to 1 second after the start of the first fluid (F₁) flow.

FIGS. 2A, 2B, 7 and 8 show according to the disclosure that the first separate supply line 30 for the first liquid F₁ is configured to open into the second end 5B of the dispense tap 5 and that the second separate supply line 40 for the second liquid F₂ is configured to open into the first and free discharge end 5A of the dispense tap 5 closer to the outlet 7 than the first separate supply line 30.

More specifically, FIGS. 1B, 2A, 2B and 5B show that the first separate supply line 30 for the first liquid F₁ extends inside the beverage dispensing font device 1 and ends and opens into a second end 5B of the dispense member 5 opposite the free dispensing end 5A and that the second separate supply line 40 for the second liquid F₂ extends inside the beverage dispensing font device 1 to the second end 5B of the dispense member 5 and extends further from the second end 5B of the dispense member 5 and out of the dispense member 5 and extends externally along the outside of the dispense member 5 and joins and ends and opens into the outlet 7 at the free end 5A of the dispense member 5. FIG. 7 shows that same design but with the outer supply lines or tubes not yet assembled thereto. FIG. 8 shows the tap 5 with no outer supply lines or tubes 40 yet assembled. In FIGS. 7, 8 and 9, the sensor 9 is assembled but not yet the sensor cable connecting the sensor 9 to one or more control units 70.

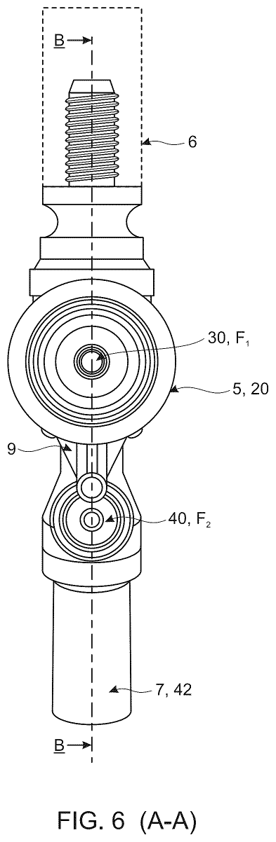

The second aspect of this disclosure is shown in FIGS. 6, 7, 8 and 9 and concerns a beverage dispensing member or tap 5 that preferably is applied in the first aspect by being operatively and fluidly coupled to one or more beverage containers 13, 14 of one or more of the beverage dispensing systems 100 according to any of the first aspects, wherein the one or more beverage containers 13, 14 are part of two separate and operatively interconnected beverage dispensing units 110, 120. According to the disclosure, a first beverage dispensing unit 110 includes one or more first containers 13 that in turn includes at least a second liquid F₂, e.g., a non-carbonated concentrate such as syrup, to be dispensed through one or more of the beverage dispensing font devices 1 and/or one or more taps 5 by means of one or more electrical pumps 41. A second beverage dispensing unit 120 includes one or more second containers 14 that in turn includes at least a first liquid F₁, e.g., water or beer, to be propelled out of the respective second container 14 by use of pressurized gas, e.g., carbon dioxide CO₂=G₁ and/or nitrogen N₂=G₂, to be dispensed through the beverage dispensing font device 1 and/or one or more taps 5 and out of the outlet(s) 7 of the beverage dispensing font device(s) 1 and/or tap(s) 5 together with the second liquid F₂ as a mixture and single drink D. This is achieved by manual handling or maneuvering, e.g., by tilting, toggling, rocking and/or pivoting of the tap handle(s) 6 of the beverage dispensing font device(s) 1 and/or the tap(s) 5, which tap handle(s) 6 is/are adapted to control the dispensing of the at least two liquids F₁, F₂ as the mixed drink D such that the propelling and dispensing of the at least first liquid F₁ is initiated, i.e., started before the dispensing of the at least second liquid F₂ is initiated, i.e., started. The one or more second containers 14 including beverage, e.g. beer or water (F₁) may instead be one or more water lines supplying water directly, e.g., water to be carbonated as part of the drink D, and/or to directly serve as cooling liquid being cold or chilled water of the cooling circuit 8 and/or to be bled off or bypassed as at least as a part or small stream of cold water from the cooling circuit 8 to be mixed with the first fluid Fi via one or more pressure regulators 80 before the first fluid F₁ is mixed with the second fluid F₂.

FIG. 6 shows the dispensing tap 5 of FIGS. 1B, 2A, 2B and 5B in a plan view from one end of the dispensing tap, i.e., the second end 5B, of the beverage dispensing system 100 as shown in FIGS. 2A and 2B as viewed along arrows A-A in a plane visualized by the dot and dashed line, i.e., as seen from the inlet end of the tap 5 and in parallel with the extension or center axis of the tap 5, after disassembly or before assembly of the dispensing tap from or to the beverage dispensing font device 1 and/or this dispensing system 100.

FIGS. 7, 8 and 9 show dispensing taps 5 with essentially or substantially the same or similar functionality and/or structure in cross-sectional views of each dispensing tap along line B-B in FIG. 6, even though FIG. 6 only shows one of the taps 5. One difference between the dispensing taps 5 shown in FIGS. 1B, 2A, 2B, 5B, 7 and 8 and the one shown in FIGS. 1A, 5A and 9 is that the supply line 40 for the second fluid F₂ and the actual flow path of the second fluid occurs or extends partly outside the dispensing tap 5 in FIGS. 1B, 2A, 2B, 5B, 7 and 8 before the fluid F₂ (and its flow path 40) enters and flows into and inside the outlet 7 before mixing with the first fluid F₁ flowing from above or upstream and is dispensed out of the inner opening 42 and thereafter finally dispensed out of the outlet 7—as the mixed drink D—while, in FIGS. 1A, 5A and 9, the supply line or channel or conduit 40 for the second fluid F₂ and the actual flow path of the second fluid occurs or extends inside the dispensing tap 5 all the way through the dispensing tap before the fluid F₂ reaches and enters and flows into the outlet 7 and out of the inner opening 42 inside the outlet 7 and into the last part of the outlet 7 to mix with the first fluid F₁ flowing from above or upstream after being discharged out of the inner opening 42 and thereafter finally dispensed out of the outlet 7 as the mixed drink D. Another difference between the tap 5 shown in FIGS. 2B and 8 and the ones shown in FIGS. 2A, 7 and 9 is that the tap 5 of FIGS. 2B and 8 includes at least one compensator 24 besides the valve 20. The compensator 24 of the tap 5 in FIGS. 2B and 8 makes the tap into a compensator tap for dispensing beverages as a specialized faucet used in draft systems, such as for beer, wine or soft drinks. It allows the operator to adjust the flow of the beverage D being dispensed, which can help manage the amount of foam produced, particularly when pouring beer. The compensator mechanism 24 is in the form of a conical member that works by restricting the flow of the first fluid F₁ delivered in the conduit 30 at the inlet end 5B and from the right of FIG. 8 and into the tap 5. The compensator 24 is adjustable by being moveable or slidable inside the tap 5—to suit the type of beverage and the desired pouring speed-to the left or the right for opening and closing more or less as visualized by a horizontal double arrow in FIG. 8. This tap 5 with compensator 24 is designed to enhance the drinking experience by providing a wide range of adjustments for beer dispensing. The compensator tap 5 also provides exceptional flow properties and is suitable for tapping all types of beverages. The tap 5 is preferably made of high-quality stainless steel and features a design that allows for quick cleaning without closing the keg. The compensator tap 5 can also comprise a “foam button” which helps to manage the foam head when pouring soft drinks, like cola or lemonade. This feature is particularly useful for beverages that are prone to foaming, ensuring a smooth and consistent pour. When setting up the beverage mixing and draft system 100 a compensator tap 5 is a valuable addition to control the flow and quality of the drink D improving the beverage dispensing.

The compensator mechanism 24 in the beverage dispensing tap 5 works by allowing the operator to adjust the flow of the beverage, which is particularly useful for managing the foam when pouring drinks like beer. Here's an explanation of how it typically works. Flow adjustment: The compensator tap 5 has a lever or knob or button 90 (see FIG. 2B) that the operator can use to adjust the flow rate. This is done by increasing or decreasing the size of the opening through which the fluid F₁ or beverage flows by moving the compensator 24 by sliding it towards the inlet to the right in FIG. 8 or away from the inlet, i.e., moving by sliding the compensator to the left in FIG. 8. Foam control: By controlling the flow into the tap 5 by means of the compensator 24, the operator can manage the amount of foam produced. A slower flow rate will generally produce less foam, which is desirable when pouring certain types of beer. Internal mechanism: Inside the tap 5, the sliding mechanism or the valve in the form of the compensator 24 moves in response to the operator's adjustments when turning the knob 90. This changes the size of the passage for the first liquid F₁ inside the tap 5 and thus controls the flow. The draft tap 5 of FIGS. 2B and 8 includes a stainless steel spout 7 and the compensator 24 to provide a consistent and controlled pour, enhancing the overall quality of the beverage service.

The number of control units 70; controllable valves 20 for the liquids F₁, F₂ including the cooling liquid in the cooling circuit 8; controllable valves 21 for the gas/-ses G₁, G₂; flow regulators 22 for the liquids F₁, F₂ including the cooling liquid in the cooling circuit 8; flow regulators 23 for the gasses G₁, G₂; and controllable valves or compensators 24 for the liquid Fi used depend on the actual size and complexity of the beverage dispensing systems 100, 110, 120, among others the number of lines and containers of fluid and/or gasses etc., hence, the applicable number of used components and entities for operation of these systems 100, 110, 120 is decided on a case-by-case basis, i.e., each user case and system 100 may be more or less complex, wherefore the same numerals used in the disclosure may be applicable for different parts or components or entities depending on the user case and system 100 but with the same and/or similar functionality, e.g., a first fluid valve 20 may be used for the first fluid F₁ and a second fluid valve 20 can be used for the second fluid F₂ and a third fluid valve 20 can be used for the cooling liquid or water of the cooling circuit 8 or one three-way valve 20 can be used for two of the fluids as seen in the lower part of FIG. 2B and so on, and all of these operatively connected components are controlled by a suitable number of control units 70, e.g., one control unit 70 controls some components while another control unit 70 controls other components of any or two or more or all of the system(s) 100, 110, 120 as a master control unit, however, one or more basic or slave-like control units 70 may also be applicable depending on the user case.

Examples of sensors 9 are level sensors, which measure the liquid level in containers to ensure precise dispensing and prevent overfilling, and technologies used for such level sensors 9 include capacitive, ultrasonic, optical, and pressure-based sensing; flow sensors, which flow sensors 9 monitor the flow rate of the beverage being dispensed, ensuring the correct volume is poured each time; temperature sensors, which temperature sensors 9 ensure the beverage is dispensed at the optimal temperature, which is crucial for maintaining quality and taste; proximity sensors, which proximity sensors 9 detect the presence of a cup or container under the dispenser, ensuring that the beverage is only dispensed when a container is in place, even though the handle 6 is tilted; pressure sensors, which pressure sensors 9 monitor the pressure within the dispensing system 100, 110, 120 to ensure consistent flow and prevent leaks. These sensors 9 work together to maintain consistency, efficiency, and quality in the beverage dispensing systems 100, 110, 120. Some sensors 9 also use magnetic capabilities to provide feedback to one or more control units 70 to control the associated fluid flow.

### NOMENCLATURE

1: Beverage dispensing font device.
2: Vertical first font part or section of font device 1 forming a tower.
3: Second font part or section or end (upper end) or neck of font device 1.
4: Third font part or lower end of font device 1.
5: Fourth font part or section or substantially horizontal font part/section or dispensing tap of font device 1 protruding from font device 1 to enable dispensing of beverage.
5A: Free end of fourth font section/dispensing tap 5.
5B: End of fourth font section and/or dispensing tap 5 connected at/to/on upper end 3.
6: Tap/Tapping handle to control dispensing of mixed fluids/beverage D.
7: Outlet or nozzle on free end 5A of horizontal font section and/or dispensing tap 5.
8: Cooling circuit of beverage dispensing font device 1.
9: Sensor in the horizontal second font part/tap 5 connected to a control unit 70.
10: Fluid/Liquid regulator.
11: Gas container with pressurized gas, such as CO₂ (G₁) or N₂ (G₂).
12: Gas supply line.
13: First container including liquid/fluid/beverage, such as concentrate or syrup or coffee or tea (F₂).
14: Second container including beverage, e.g., beer or water (F₁) or a water line.
15: Insulation to keep liquids sufficiently cool.
16: Dispense head of a beer or water (F₁) container 14.
20: Controllable valve(s) for liquids F₁, F₂ incl. cooling liquid in cooling circuit.
21: One or more controllable valves for the gas/gasses G₁, G₂.
22: One or more flow regulators for the liquids F₁, F₂
23: One or more flow regulators for the gasses G₁, G₂
24: One or more controllable valves or movable compensators for the liquid F₁.
30: First/Main/Primary line/conduit for supply/flow of first/main fluid/liquid F₁
40: Second/Secondary line/tube/conduit for supply of second/secondary fluid/liquid F₂
41: Electrical pump for flow of second/secondary fluid/liquid F₂
42: Inner tube end/bend/elbow acting as stiff/rigid/hard nozzle/opening for discharge of the secondary fluid F₂ into and further out of outlet 7 together with main fluid F₁
50: Guiding manifold/channel for gathering/accommodating/leading supply lines from different sources and through font device 1.
60: Housing(s) or room(s) keeping beverage and container/-s 14 cold or warm/hot.
61: Cooling device for cold housing(s)/room(s).
70: One or more control units.
80: Pressure regulator.
90: Adjuster/Button/Lever/Knob for moving compensator 24.
100: Beverage dispensing system.
110: First liquid/fluid/beverage/syrup/coffee/tea dispensing unit including one or more liquid/fluid/beverage/syrup/coffee/tea (F₂) containers.
120: Second beverage/beer/water dispensing unit including one or more beer or water (F₁) containers or water lines for supply of water.
200: Electrical wiring.
D: Common/Single beverage/drink dispensed after mixing of at least two liquids
F₁: One/First/Main/Primary fluid/liquid/beverage
F₂: Another/Second/Auxiliary/Secondary fluid/liquid/beverage
G₁: One/First gas, such as carbon dioxide (CO₂) used as propellant/-ent for flow and carbonizing of the first/main/primary fluid/liquid/beverage F₁
G₂: Another/Second gas, such as nitrogen (N₂) used as propellant/-ent for flow of the first/main/primary fluid/liquid/beverage F₁

### ADDITIONAL INFORMATION

Item 1. A beverage mixing and dispensing system (100) configured to dispense a drink (D) of a mixture of at least a first main liquid (F₁), e.g. water or beer, and of a second liquid (F₂), e.g. a concentrate such as syrup, by use of one or more electrical pumps (41), one or more propellants (11, G₁, G₂), one or more regulators (10), one or more valves (20, 21), one or more gas and liquid flow regulators (22, 23), one or more sensors (9), and one or more control units (70) operatively connected to enable operation and flow of liquids and propellants from one or more containers (13, 14) containing the liquids (F₁, F₂) when dispensing the drink (D) via one or more beverage dispensing font devices (1) and/or dispense/dispensing members/taps (5), wherein a beverage dispensing font device (1) includes and one or more of the dis-pense/dispensing members or taps (5) protruding from the beverage dispensing font device (1) into a free dispense end (5A) including a tapping handle (6) to manually control dispensing of the drink (D) from an outlet (7) at the free dispense end (5A), the beverage dispensing font device (1) includes a inner guide channel (50) to guide and accommodate a cooling circuit (8) to provide or keep the liquids (F₁, F₂) and the drink (D) at a predetermined temperature until being dispensed out of the outlet (7) at the free dispense end (5A) and a first separate supply line (30) for the first liquid (F₁) and a second separate supply line (40) for the second liquid (F₂), which supply lines (30, 40) are arranged to be in fluid communication with the outlet (7) at the free dispense end, whereby the flows of the liquids (F₁, F₂) are controlled by the tapping handle (6) being operatively connected to the control unit/-s (70) configured to operate the valve/-s (20, 21), the flow regulator/-s (22, 23), the electrical pump/-s (41) and the propellant/-s (11, G₁, G₂) in response to activation or de-activation of the dispensing of the drink (D) by means of tilting the tapping handle (6), preferably by help of feedback from the one or more sensors (9) arranged in the dispensing tap(s) (5) and operatively connected to the control unit/-s (70), wherein the first separate supply line (30) for the first liquid (F₁) and the second separate supply line (40) for the second liquid (F₂) are arranged to enable the separate flows of each liquid to join and mix at the outlet (7) of the free dispense end (5A) of the dispensing tap(s) when activating the dispensing by means of operating, preferably via manual tilting of the tapping handle (6) that triggers the control unit/-s (70) to operate the valve/-s (20, 21), the flow regulator/-s (22, 23), the electrical pump/-s (41) and the propellant/-s (11, G₁, G₂) to enable flow of each liquid through the supply lines (30, 40) and to the outlet (7) at the free dispense end of the dispensing tap(s) (5) in a synchronized manner by initiating the separate flow of the first liquid (F₁) before initiating the separate flow of the second liquid (F₂).
Item 2. The beverage mixing and dispensing system (100) according to item 1, wherein the separate flow of the first liquid (F₁) is initiated shortly before the separate flow of the second liquid (F₂) is initiated.
Item 3. The beverage mixing and dispensing system (100) according to any preceding item, wherein the separate flow of the first liquid (F₁) is initiated about between 0.1 second to 3 seconds before the separate flow of the second liquid (F₂) is initiated or the separate flow of the first liquid (F₁) is preferably initiated about between 0.1 second to 2 seconds before the separate flow of the second liquid (F₂) is initiated or the separate flow of the first liquid (F₁) is more preferred initiated about between 0.1 second to 1 second before the separate flow of the second liquid (F₂) is initiated.
Item 4. The beverage mixing and dispensing system (100) according to any preceding item, wherein the separate flow and carbonization of the first liquid (F₁) is initiated before the separate flow of the second and non-carbonated liquid (F₂) is initiated.
Item 5. The beverage mixing and dispensing system (100) according to any preceding item, wherein the first separate supply line (30) for the first liquid (F₁) is configured to open into the second end (5B) of the dispense/dispensing tap/member (5) upstream an inner opening (42) configured to discharge the secondary fluid (F₂) coming from the second separate supply line (40) inside the outlet (7) of the dispense/dispensing tap/member (5).
Item 6. The beverage mixing and dispensing system (100) according to item 5, wherein the inner opening (42) of the second separate supply line (40) for discharge of the second fluid (F₂) is configured to open into and inside the outlet (7) of the dispense/dispensing member/tap (5) closer to the outlet (7) than the first separate supply line (30).

Item 7. The beverage mixing and dispensing system (100) according to any preceding item, wherein the first separate supply line (30) for the first liquid (F₁) is configured to extend inside the beverage dispensing font device (1) and to end and open into a second end (5B) of the dispense member/tap (5) opposite the free end (5A) and the second separate supply line (40) for the second liquid (F₂) is configured to extend inside the beverage dispensing font device (1) to the second end (5B) of the dispense member/tap (5) and to extend from the second end (5B) of the dispense member/tap (5) out of and outside of the dispense member/tap (5) and to join and end and open into the outlet (7) at the free end (5A) of the dispense member/tap.
Item 8. The beverage mixing and dispensing system (100) according to any of items 1 to 6, wherein the first separate supply line (30) for the first liquid (F₁) is configured to extend inside the beverage dispensing font device (1) and to end and open into a second end (5B) of the dispense member/tap (5) opposite the free end (5A) and the second separate supply line (40) for the second liquid (F₂) is configured to extend inside the beverage dispensing font device (1) to the second end (5B) of the dispense member/tap (5) and to extend from the second end (5B) of the dispense member/tap (5) inside the dispense member/tap and end and open into the outlet (7) at the free end (5A) of the dispense member/tap (5) downstream of the opening of the first separate supply line (30).
Item 9. A beverage dispensing tap (5) system configured to be operatively and fluidly coupled to one or more beverage containers (13, 14), wherein the one or more beverage containers (13, 14) are part of two separate and operatively interconnected beverage dispensing units (110, 120) fluidly coupled to the beverage dispensing tap (5), a first beverage dispensing unit (110) including one or more first containers (13) that in turn includes at least a first or a second liquid (F₂), e.g. a non-carbonated concentrate such as syrup, configured to be dispensed through the beverage dispensing tap by means of one or more electrical pumps (41) and a second beverage dispensing unit (120) including one or more second containers (14) that in turn includes at least a second or a first liquid (F₁), e.g. water or beer, configured to be propelled out of the respective container (14) by use of pressurized gas, e.g. carbon dioxide (CO₂=G₁) and/or nitrogen (N₂ =G₂), to be dispensed through the beverage dispensing tap and out of the outlet (7) of the beverage dispensing tap (5) together with the second liquid (F₂) as a mixture and single drink (D) by means of operating, preferably by manually tilting, a tap handle (6) of the beverage dispensing tap configured to thereby control the dispensing of the at least two liquids (F₁, F₂) as the mixed drink (D) such that the propelling and dispensing of the at least first liquid (F₁) is initiated before the dispensing of the at least second liquid (F₂) is initiated.
Item 10. The beverage dispensing tap (5) system according to item 9, wherein the separate flow of the first liquid (F₁) is initiated shortly before the separate flow of the second liquid (F₂) is initiated.
Item 11. The beverage dispensing tap (5) system according to item 9 or 10, wherein the separate flow of the first liquid (F₁) is initiated about between 0.1 second to 3 seconds before the separate flow of the second liquid (F₂) is initiated or the separate flow of the first liquid (F₁) is preferably initiated about between 0.1 second to 2 seconds before the separate flow of the second liquid (F₂) is initiated or the separate flow of the first liquid (F₁) is more preferred initiated about between 0.1 second to 1 second before the separate flow of the second liquid (F₂) is initiated.
Item 12. The beverage dispensing tap (5) system according to any of items 9 to 11, wherein the separate flow and carbonization of the first liquid (F₁) is initiated before the separate flow of the second and non-carbonated liquid (F₂) is initiated.
Item 13. The beverage dispensing tap (5) system according to any of items 9 to 12, wherein the first separate supply line (30) for the first liquid (F₁) is configured to open into the second end (5B) of the dispense/dispensing tap/member (5) upstream an inner opening (42) configured to discharge the secondary fluid (F₂) coming from the second separate supply line (40) inside the outlet (7) of the dispense/dispensing tap/member.
Item 14. The beverage dispensing tap (5) system according to item 13, wherein the inner discharge opening (42) of the second separate supply line (40) is configured to open into the dispensing tap (5) at/in the free dispense end (5A) closer to the outlet (7) than the opening of the first separate supply line (30).
Item 15. The beverage dispensing tap (5) system according to any of items 9 to 14, wherein the first separate supply line (30) for the first liquid (F₁) is configured to extend into the beverage dispensing tap (5) and to end and open into a second end (5B) of the dispensing tap (5) opposite the free discharge end (5A) and the second separate supply line (40) for the second liquid (F₂) is configured to extend from the second end (5B) of the dispensing tap out of and outside of the dispensing tap and to join and end and open into the outlet (7) at the free end (5A) of the dispensing tap (5) and the inner discharge opening (42) inside the outlet (7).
Item 16. The beverage dispensing tap (5) system according to any of items 9 to 14, wherein the first separate supply line (30) for the first liquid (F₁) is configured to extend into the beverage dispensing tap (5) and to end and open into a second end (5B) of the dispensing tap (5) opposite the free dispensing end (5A) and the second separate supply line (40) for the second liquid (F₂) is configured to extend from the second end (5B) of the dispensing tap (5) inside the dispensing tap and end and open into the outlet (7) and the discharge opening (42) inside and at the free end (5A) of the dispensing tap (5) downstream of the opening of the first separate supply line (30).
Item 17. The beverage dispensing tap (5) system according to any of items 9 to 16 including an adjustable compensator (24) configured to control the flow of the at least first liquid (F₁).

1. A beverage mixing and dispensing system configured to dispense a drink of a mixture of at least a first liquid and a second liquid, the beverage mixing and dispensing system comprising:
an electrical pump, a propellant, a regulator, a valve, a gas and liquid flow regulator, a sensor, and a control unit operatively connected to enable operation and flow of liquids and a propellant from one or more containers containing a first liquid and a second liquid when dispensing a drink via at least one beverage dispensing font device, wherein the beverage mixing and dispensing font device comprises:
a dispense/dispensing member or tap protruding from the beverage dispensing font device into a free dispense end comprising a tapping handle to manually control dispensing of the drink from an outlet at the free dispense end;
an inner guide channel to guide and accommodate a cooling circuit to provide or keep the first liquid, the second liquid, and the drink at a predetermined temperature until being dispensed out of the outlet at the free dispense end; and
a first supply line for the first liquid and a second supply line for the second liquid, wherein the first supply line and the second supply line are arranged to be in fluid communication with the outlet at the free dispense end, wherein flow of the first liquid and flow of the second liquid are controlled by the tapping handle being operatively connected to the control unit configured to operate the valve, the flow regulator, the electrical pump, and the propellant in response to activation or de-activation of the dispensing of the drink by tilting the tapping handle;
wherein the first supply line for the first liquid and the second supply line for the second liquid are arranged to enable the flow of the first liquid and the flow of the second liquid to combine and mix at the outlet of the free dispense end of the dispense/dispensing member or tap when activating the dispensing by triggering the control unit to operate the valve, the flow regulator, the electrical pump, and the propellant to enable flow of the first liquid through the first supply line and flow of the second liquid through the second supply line to the outlet at the free dispense end of the dispensing tap in a synchronized manner by initiating the flow of the first liquid before initiating the flow of the second liquid.

2. The beverage mixing and dispensing system according to claim 1, wherein the flow of the first liquid is initiated shortly before the flow of the second liquid is initiated.

3. The beverage mixing and dispensing system according to claim 1, wherein the flow of the first liquid is initiated between 0.1 to 3 seconds before the flow of the second liquid is initiated.

4. The beverage mixing and dispensing system according to claim 1, wherein the flow of the first liquid and carbonization of the first liquid is initiated before the flow of the second liquid is initiated, wherein the second liquid is non-carbonated.

5. The beverage mixing and dispensing system according to claim 1, wherein the first supply line for the first liquid is configured to open into a second end of the dispense/dispensing member or tap upstream of an inner opening configured to discharge the second fluid coming from the second supply line inside the outlet of the dispense/dispensing member or tap.

6. The beverage mixing and dispensing system according to claim 5, wherein the inner opening of the second supply line for discharge of the second fluid is configured to open into and inside the outlet of the dispense/dispensing member or tap closer to the outlet than the first supply line.

7. The beverage mixing and dispensing system according to claim 1, wherein the first supply line for the first liquid is configured to extend inside the beverage dispensing font device and to end and open into a second end of the dispense/dispensing member or tap opposite the free dispense end and the second supply line for the second liquid is configured to extend inside the beverage dispensing font device to the second end of the dispense/dispensing member or tap and to extend from the second end of the dispense/dispensing member or tap out of and outside of the dispense/dispensing member or tap and to join and end and open into the outlet at the free end of the dispense/dispensing member or tap.

8. The beverage mixing and dispensing system according to claim 1, wherein the first supply line for the first liquid is configured to extend inside the beverage dispensing font device and to end and open into a second end of the dispense/dispensing member or tap opposite the free dispense end and the second separate supply line for the second liquid is configured to extend inside the beverage dispensing font device to the second end of the dispense/dispensing member or tap and to extend from the second end of the dispense/dispensing member or tap inside the dispense/dispensing member or tap and end and open into the outlet at the free dispense end of the dispense/dispensing member or tap downstream of the opening of the first supply line.

9. A beverage dispensing tap system configured to be operatively and fluidly coupled to one or more beverage containers, wherein the one or more beverage containers are part of two separate and operatively interconnected beverage dispensing units fluidly coupled to the beverage dispensing tap, wherein the beverage dispensing tap system comprises:
a first beverage dispensing unit comprises a first container that comprises a first liquid configured to be dispensed through a beverage dispensing tap by an electrical pump;
a second beverage dispensing unit comprises a second container that comprises a second liquid configured to be propelled out of the second container by use of pressurized gas to be dispensed through the beverage dispensing tap and out of an outlet of the beverage dispensing tap together with the first liquid as a mixture and single drink by operating a tap handle that controls the dispensing of the first liquid and the second liquid as the mixed drink such that the propelling and dispensing of the second liquid is initiated before the dispensing of the first liquid is initiated.

10. The beverage dispensing tap system according to claim 9, wherein the separate flow of the second liquid is initiated shortly before the separate flow of the first liquid is initiated.

11. The beverage dispensing tap system according to claim 9, wherein the separate flow of the second liquid is initiated about between 0.1 to 3 seconds before the separate flow of the first liquid is initiated.

12. The beverage dispensing tap system according to claim 9, wherein the separate flow of the second liquid and carbonization of the second liquid is initiated before the separate flow of the first liquid is initiated, wherein the first liquid is non-carbonated liquid.

13. The beverage dispensing tap system according to claim 9, wherein a second supply line for the second liquid is configured to open into a second end of the dispense/dispensing member or tap upstream an inner opening configured to discharge the first fluid coming from a first supply line inside the outlet of the dispense/dispensing member or tap.

14. The beverage dispensing tap system according to claim 13, wherein the inner opening of the first supply line is configured to open into the dispense/dispensing member or tap at/in the free dispense end closer to the outlet than the opening of the second supply line.

15. The beverage dispensing tap system according to claim 9, wherein a second supply line for the second liquid is configured to extend into the beverage dispense/dispensing member or tap and to end and open into a second end of the dispense/dispensing member or tap opposite a free discharge end and the first supply line for the first liquid is configured to extend from the second end of the dispense/dispensing member or tap out of and outside of the beverage dispensing tap and to join and end and open into the outlet at the free discharge end of the dispense/dispensing member or tap and the inner discharge opening inside the outlet.

16. The beverage dispensing tap system according to claim 9, wherein the second supply line for the second liquid is configured to extend into the beverage dispensing tap and to end and open into a second end of the beverage dispensing tap opposite the free dispensing end and the first supply line for the first liquid is configured to extend from the second end of the dispensing tap inside the dispensing tap and an end and open into the outlet and the discharge opening inside and at the free end of the dispensing tap downstream of the opening of the second supply line.

17. The beverage dispensing tap system according to claim 9, further comprising an adjustable compensator configured to control the flow of the second liquid.
